(19) United States
(12) Patent Application Publication
(10) Pub. No.: US 2007/0086275 A1
(43) Pub. Date: Apr. 19, 2007

(54) Electronic reminder device

(76) Inventors: Robert J. Robinson, Jamison, PA (US); George Ming Fai Chan, Hong Kong (HK)

Correspondence Address: ROBERTS & ROBERTS, LLP;ATTORNEYS AT LAW, P.O. BOX 484, PRINCETON, NJ, 08542-0484, US

(21) Appl. No.: 11/496,056

(22) Filed: Jul. 28, 2006

Related U.S. Application Data
(60) Provisional application No. 60/727,780, filed on Oct. 18, 2005.

(51) Int. Cl. G04C 21/00

(52) U.S. Cl. 368/72

(57) ABSTRACT

An electronic data device used for reminding a user of an event, deadline, appointment, or the like. The device includes a housing which contains internal electronic components such as a microprocessor coupled to a data memory. These internal components are electrically coupled to external electronic components of the housing such as an input arrangement, for entering time and/or date data into the data memory, a data entry display for displaying the entry of data into the data memory, and a reminder display for indicating including an array of lights for displaying signals which indicate a continuous countdown of time corresponding to the time and/or date data from the data memory. In one embodiment the device includes an clip attachment mechanism for attaching the device to an article such as a file folder, a refrigerator, or the like.

### CROSS REFERENCE TO RELATED APPLICATION

This application claims the benefit of U.S. provisional patent application Ser. No. 60/727,780 filed Oct. 18, 2006, which is incorporated herein by reference.

### BACKGROUND OF THE INVENTION

1. Field of the Invention

The invention relates to electronic data devices capable of displaying a continuous countdown of time. The invention includes an electronic reminder device having a continuous visual reminder display for continuously reminding a user of an impending deadline or event.

2. Description of the Related Art

For centuries, various reminder methods have been developed to assist in the recollection of tasks and events. For instance, it has been known to use an alarm clock as a reminder that an event or deadline is imminent.

As global technology advances, and the speed of information transmission increases, so do the pressures of organizing one's business appointments, keeping track of deadlines, scheduling events, and the like. These days, computerized calendars are often used for organizing such information. A user enters time or date information into the computer's memory using a computer desktop calendar program. Online computerized calendars are also available from some internet service providers, wherein a user logs in to a personal internet account and enters time or date information into an online calendar, which information is then saved on the ISP's server. Computerized calendar users are reminded of their entered events upon viewing the calendar, or upon setting a calendar reminder. However, a user is typically only reminded of such computerized calendar events if his/her computer is turned on.

Many personal digital assistants (PDAs), or small hand-held computers, contain integrated computerized calendars or schedulers as well. The calendar functions of a PDA are similar to those of a desktop computer. Like computers, however, these devices often only provide a one-time alert or alarm as a reminder of an event.

It would be desirable to formulate an inexpensive electronic reminder device which provides a visual countdown signal, indicating a continuous countdown of time relating to an event. The inventive device is preferably attachable to an article such as a file or other papers on a user's desk, to remind the user that a particular task or event relating to that file is imminent.

Accordingly, the present invention provides an electronic data device capable of displaying a continuous visual countdown of time. The electronic data device may comprise an electronic reminder device which conveniently serves as an attachable reminder system. In one embodiment, the electronic reminder device includes a housing capable of being attached to an article; a microprocessor coupled to a data memory; an input arrangement is capable of entering time and/or date data into the data memory; and a data display. The data display preferably includes entry display portion and a reminder display portion. The entry display portion is capable of displaying the entry of time and/or date data, relating to an event, into the data memory. The reminder display portion is capable of displaying a signal which indicates a continuous countdown of time responsive to time and/or date data recalled from the data memory and relating to the event. Preferably the reminder display portion includes a plurality of LED lights are capable of displaying a sequential illumination signal, to indicate a countdown of time, responsive to time and/or date data recalled from the data memory. The invention further includes other electronic data devices, such hand held electronic data devices including data storage organizers, for example PDA's, which include an array of countdown lights such as a plurality of sequentially illuminating LED lights as described herein.

### SUMMARY OF THE INVENTION

The invention provides an electronic reminder device which comprises:

a) a housing comprising an attachment mechanism for attaching the housing to an article;

b) a microprocessor within the housing, which microprocessor is coupled to a data memory which stores time and/or date data; and which microprocessor is capable of conducting a continuous countdown of time corresponding to the time and/or date data stored in the data memory;

c) an input arrangement coupled to the microprocessor, for entering time and/or date data into the data memory via the microprocessor;

d) a data entry display coupled to the microprocessor, for displaying the entry of time and/or date data into the data memory; and

e) a reminder display comprising an array of lights coupled to the microprocessor for displaying signals which indicate a continuous countdown of time corresponding to the time and/or date data from the data memory.

The invention also provides a method of reminding a user of an event, which method comprises:

I) providing an electronic reminder device which comprises

a) a housing comprising an attachment mechanism for attaching the housing to an article;
b) a microprocessor within the housing, which microprocessor is coupled to a data memory which stores time and/or date data; and which microprocessor is capable of conducting a continuous countdown of time corresponding to the time and/or date data stored in the data memory;
c) an input arrangement coupled to the microprocessor, for entering time and/or date data into the data memory via the microprocessor;
d) a data entry display coupled to the microprocessor, for displaying the entry of time and/or date data into the data memory; and
e) a reminder display comprising an array of lights coupled to the microprocessor for displaying signals which indicate a continuous countdown of time corresponding to the time and/or date data from the data memory;
   II) entering time and/or date data with the input arrangement, into the data memory via the microprocessor, which time and/or date data is displayed on the data entry display and wherein the time and/or date data relates to an event; and
   III) monitoring signals of the reminder display, which signals indicate a continuous countdown of time responsive to time and/or date data recalled of the data memory and relating to the event, thereby reminding a user of the event.

The invention further provides a hand held electronic data device which comprises:

a) a housing;

b) a microprocessor within the housing, which microprocessor is coupled to a data memory which stores time and/or date data; and which microprocessor is capable of conducting a continuous countdown of time corresponding to the time and/or date data stored in the data memory;

c) an input arrangement coupled to the microprocessor, for entering time and/or date data into the data memory via the microprocessor;

d) a data entry display coupled to the microprocessor, for displaying the entry of time and/or date data into the data memory; and

e) a reminder display comprising an array of lights coupled to the microprocessor for displaying signals which indicate a continuous countdown of time corresponding to the time and/or date data from the data memory.

### BRIEF DESCRIPTION OF THE DRAWINGS

FIG. 1 shows a front perspective view of an electronic data device of the invention secured to a removable attachment mechanism which includes a substantially planar clip.

FIG. 2 shows a bottom view of an electronic data device of the invention secured to a removable attachment mechanism which includes a substantially planar clip.

FIG. 3 shows a front view of an electronic data device of the invention secured to a removable attachment mechanism which includes a substantially planar clip.

FIGS. 4 and 5 show left and right side views, respectively, of an electronic data device of the invention secured to a removable attachment mechanism.

FIG. 6 shows a top view of an electronic data device of the invention secured to a removable attachment mechanism which includes a substantially planar clip.

FIG. 7 shows a rear view of removable attachment mechanism which includes a substantially planar clip.

FIG. 8 shows an exploded view of an electronic data device of the invention to be secured to a removable attachment mechanism which includes a substantially planar clip.

FIG. 9 shows a front view of an electronic data device of the invention having a reminder display including an array of lights along a side of its housing.

FIG. 10 shows a front view of an electronic data device of the invention having a reminder display including an array of lights along a bottom of its housing.

### DETAILED DESCRIPTION OF THE INVENTION

The invention relates to electronic data devices, such as electronic reminder devices, capable of displaying a continuous countdown of time. One embodiment of the invention includes an electronic reminder device having an attachment mechanism for attaching the device to an article. In another embodiment, the electronic data device comprises a hand held electronic data device, such as a data storage organizer or PDA, having an array of reminder lights.

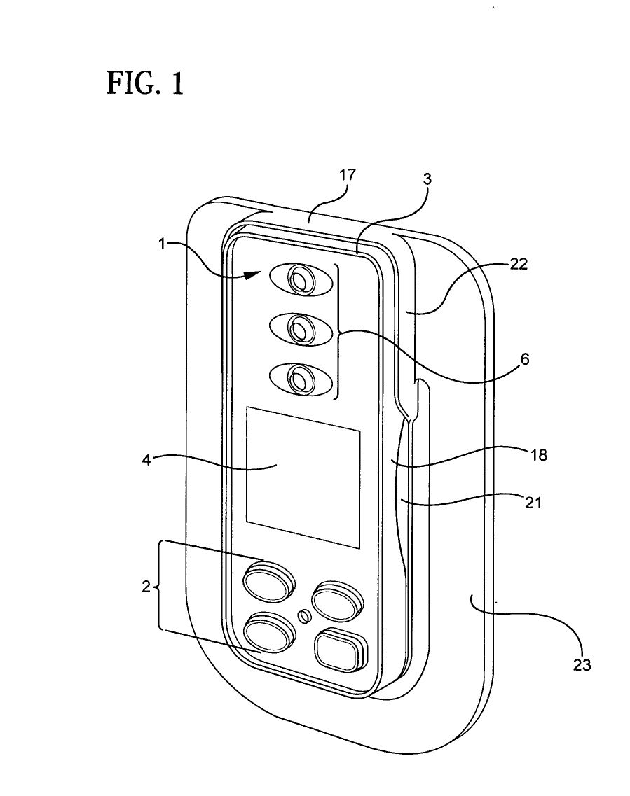

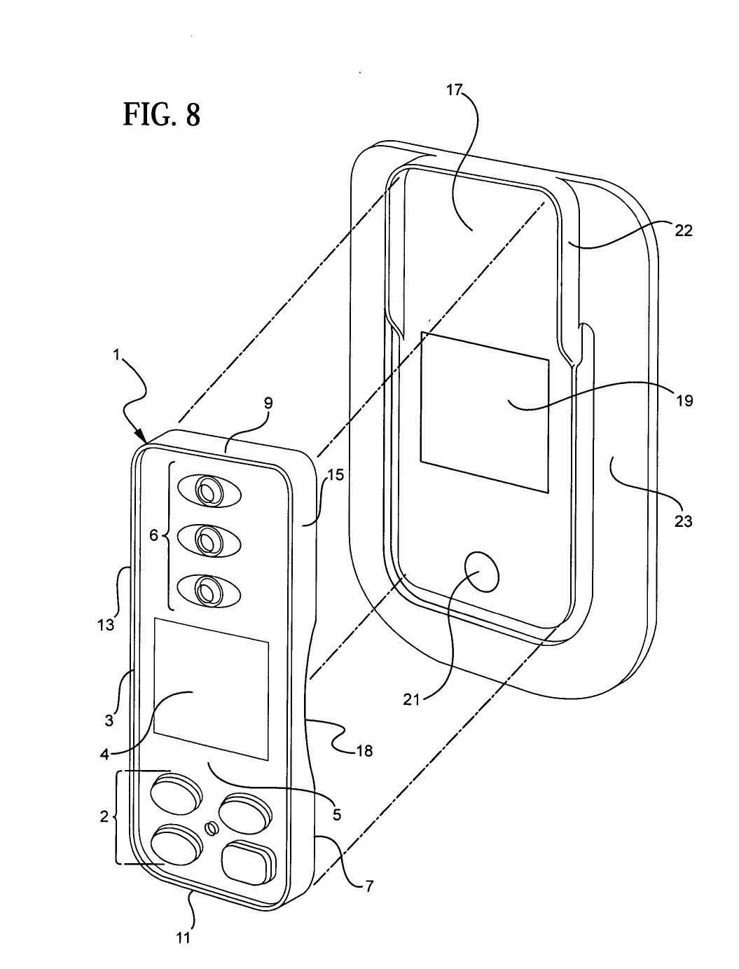

FIGS. 1, 3, 4, 5, and 8 show an electronic data device 1 of the invention, wherein the electronic data device 1 comprises an electronic reminder device. In particular, FIG. 8 shows a front perspective view of an electronic data device 1 includes a housing 3 having a front surface 5 and a rear surface 7, a top edge 9, a bottom edge 11, and left and right side edges 13 and 15 respectively. The housing 3 serves as a protective structure for encasing various components of the invention such as a microprocessor, electronic circuitry, internal power source, and the like. The housing 3 may comprise multiple panels which are secured together, such as via screws or the like, to encase such components of the inventive device. The front and rear surfaces, 5 and 7, respectively, are preferably substantially flat or planar. Preferably, the housing 3 is formed into a compact pocket sized shape which can comfortably fit into a user's hand. However, other shapes and sizes are contemplated within the scope of this invention. The housing 3 may comprise plastic, metal, rubber, or any other material known in the art for forming a protective structure, and combinations thereof. In a preferred embodiment, the housing 3 comprises a plastic material.

In a preferred embodiment, the housing 3 comprises an attachment mechanism 17 for attaching the housing 3 of the electronic data device 1 to an article such as a refrigerator, or the like. As shown in FIGS. 1 and 8 the attachment mechanism 17 is preferably secured to a rear surface 7 of the housing 3. Examples of suitable attachment mechanisms nonexclusively include spring loaded clips, slidable clips, magnets, clamps, elastic bands, hook and burr material, snaps, buttons, hooks, and the like, and combinations thereof. The attachment mechanism may comprise any suitable material such as plastic, metal, and the like.

The attachment mechanism 17 preferably has front and rear surfaces, and is preferably substantially planar. In certain embodiments, the attachment mechanism 17 comprises a magnet for magnetically attaching the electronic data device 1 to a substantially planar metal article such as a refrigerator or the like.

The attachment mechanism 17 may be removable or non-removable from the housing 3. That is, the attachment mechanism 17 and the housing 3 may be permanently attached, or may be alternately attachable and detachable from each other. FIGS. 1 and 8 show embodiments wherein a removable attachment mechanism 17 is slidably attachable to and detachable from the housing 3. FIG. 8 shows a removable attachment mechanism 17 which comprises a substantially planar magnet 19 on a front surface of the attachment mechanism 17. In this embodiment, the housing 3 of the electronic data device 1 of the invention is attached to the front surface of the attachment mechanism 17 via a magnetic force acting between the magnet 19, and a metal panel or the like of a rear surface 7 of the housing 3. Articles such as papers or the like may be held between the housing 3 and the attachment mechanism 17 by this magnetic force. The attachment mechanism 17 may further comprise a rear surface magnet 20, shown in FIG. 7, for attachment of the attachment mechanism 17 to a refrigerator or the like. Alternatively, a housing 3 may be snapped onto or otherwise mechanically secured to the attachment mechanism 17. As shown in FIG. 8, the attachment mechanism 17 may further comprise a protrusion 21 and a raised lip 22 on its front surface of the attachment mechanism 17, for securing the housing 3 to the attachment mechanism 17 such that a top edge 9 of the housing 3 corresponds to the raised lip 22, and a recessed groove 18 of the rear surface 7 of the housing 3 corresponds to the protrusion 21.

In certain embodiments, the attachment mechanism 17 comprises a substantially planar clip 23 for clipping the electronic data device 1 to a substantially planar article such as a file folder or the like. FIGS. 1, 3, and 8 show front views of a removable attachment mechanism 17 which comprises such a substantially planar clip 23. Articles such as papers or the like may be held between the housing 3 and the attachment mechanism 17 via the clip 23.

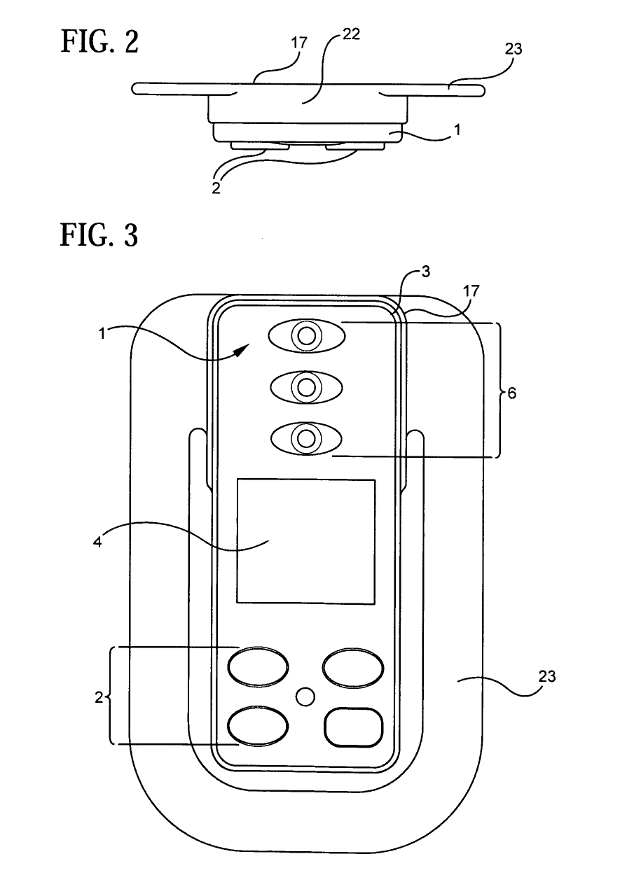

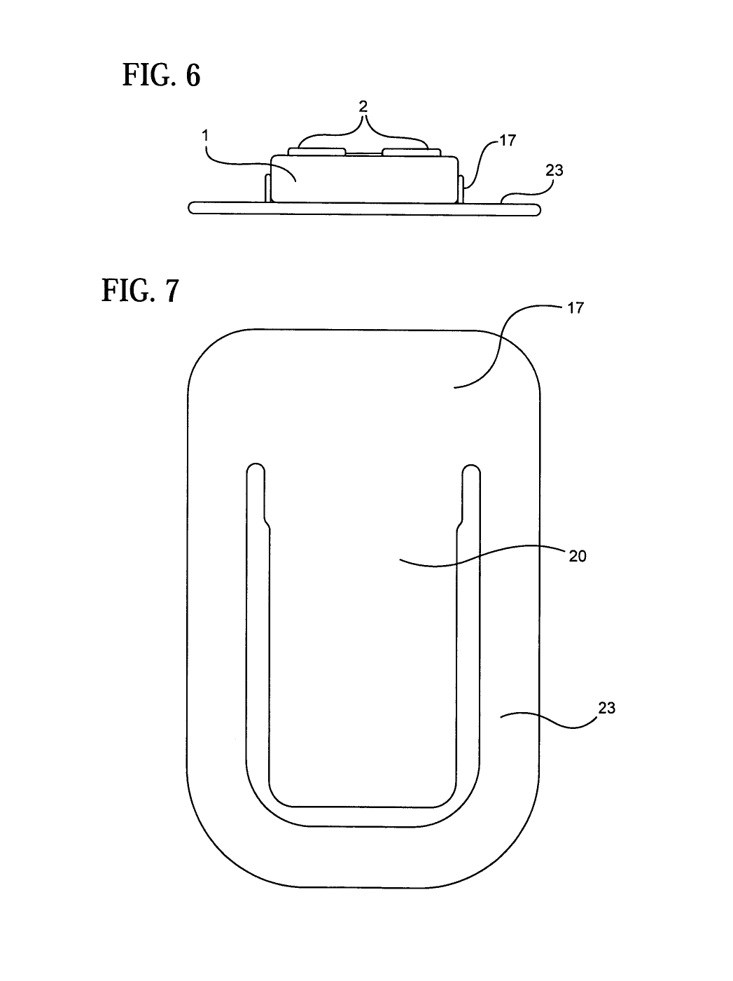

The embodiment shown in FIG. 8 further includes magnet 19 on a front surface of the attachment mechanism 17, for attaching a housing 3 of the electronic data device 1 to the attachment mechanism 17, via a magnetic force acting between the magnet 19 and a metal panel or the like on a rear surface 7 of the housing 3. The attachment mechanism 17 may further comprise a rear surface magnet 20, such as that shown in FIG. 7, for attaching of the attachment mechanism 17 to a refrigerator or the like. FIGS. 2 and 6 show top and bottom views, respectively, of an electronic data device 1 of the invention which is secured to a removable attachment mechanism 17

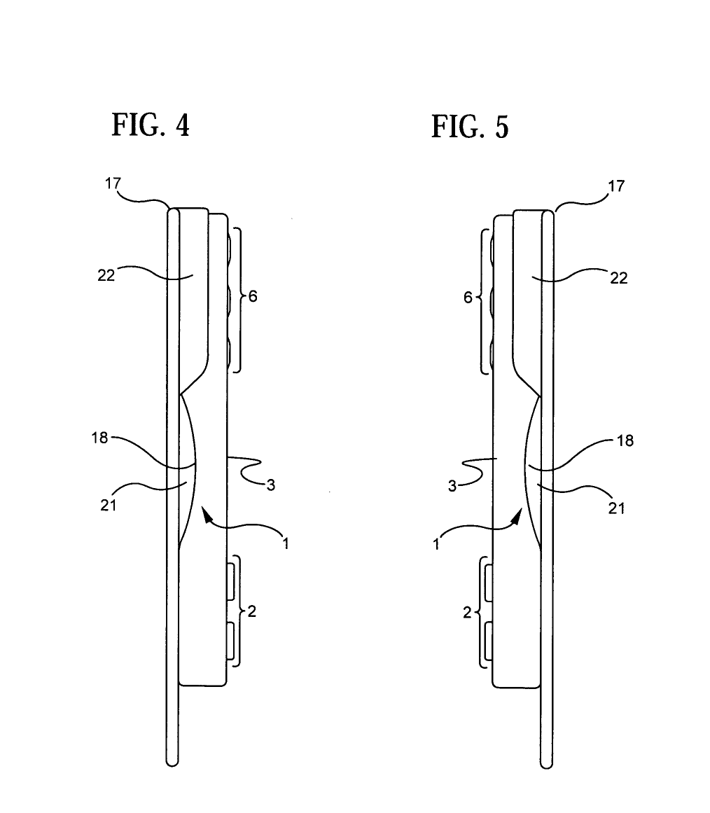

FIGS. 4 and 5 show left and right side views, respectively, of a an electronic data device 1 of the invention, which is secured to a removable attachment mechanism 17 as described above. In various embodiments, the attachment mechanism 17 may or may not include a substantially planar clip 23.

In certain embodiments, the attachment mechanism 17 is not removable from the housing 3. For example, the attachment mechanism 17 may be an integral component of the housing 3, such that the housing 3 and the attachment mechanism 17 are present together in the form of a single unit. For example, the attachment mechanism 17 may be present in the form of a substantially planar magnet which is built into the rear surface 7 of the housing. Alternatively, the attachment mechanism 17 may comprise an integral clip or the like which is built into the rear panel of the housing.

Examples of suitable articles, which the electronic data device 1 may be attached to via the attachment mechanism 17, nonexclusively include papers, folders, files, desks, cabinets, lockers, walls, refrigerators, and the like. In a preferred embodiment of the invention, the article attached to the electronic data device 1 via the attachment mechanism 17 comprises an object which relates to an event or deadline corresponding to the time and/or date data of the data memory, as described below.

The electronic data device 1 of the invention includes a data memory within the housing 3, which data memory is capable of storing time and/or date data. Such time and/or date data may be entered using an input arrangement, as described below. Such time and/or date data may relate to time of day, day of the week, date, month, and year information and the like. The time and/or date data entered into the data memory preferably relates to an event or deadline, which a user is to be reminded of. The data memory may be further capable of receiving and/or storing other forms of data such as numeric data and/or alphanumeric data. Such data memories are well known in the art.

The electronic data device 1 of the invention includes a microprocessor within the housing 3. The microprocessor is preferably coupled to the data memory. They are preferably electrically coupled via internal wires within the housing 3. The microprocessor is capable of conducting a continuous countdown of time corresponding to time and/or date data stored in and/or recalled from the data memory. The microprocessor may also serve further processing functions such as processing other numeric and/or alphanumeric data which has been entered into the data memory. Examples of functions which may be performed by the microprocessor nonexclusively include numeric calculator functions, graphing functions, mapping functions, data organization functions, and word functions such as word processing. The microprocessor may also be capable of spell checking, thesaurus, and language translation functions, and the like. Such microprocessors are known in the art such as from U.S. Pat. Nos. 5,625,673, 5,818,924 and 5,548,477 which are incorporated herein by reference.

As shown in FIG. 8, an input arrangement 2 is present at a front surface 5 of the housing 3. The input arrangement 2 is preferably internally coupled to the microprocessor such that the input arrangement 2 is capable of entering time and/or date data into the data memory via the microprocessor. They are preferably electrically coupled via internal wires within the housing 3. The input arrangement 2 may be further capable of inputting additional numeric and/or alphanumeric data and/or functional commands into the data memory and/or the microprocessor.

The input arrangement 2 may comprise any conventional data inputting means known to those skilled in the art such as a keypad, a touch screen, and the like. FIG. 8 shows one preferred embodiment where the input arrangement 2 comprises a keypad having least one depressible key or button for inputting data into the microprocessor. The time and/or date data may be entered in any suitable manner, such as by pressing keys of the input arrangement 2 associated with such times and/or dates. In an alternate embodiment, data may be entered into the microprocessor by touching a touch screen with a pen or stylus. Such input arrangements are well known in the art.

The inventive electronic data device 1 further comprises a data entry display 4 coupled to the microprocessor. They are preferably electrically coupled via internal wires within the housing 3. This data entry display 4 serves to display time and/or date data as it is entered into the data memory with the input arrangement 2. The data entry display 4 may comprise any conventionally known display means for visually displaying data, such as a black and white or color screen. In a most preferred embodiment, the data entry display 4 comprises a liquid crystal display (LCD) screen as shown in FIG. 8. Other known displays nonexclusively include light-emitting diode displays, backlighted screen displays, and the like.

Once entered, the data entry display 4 may continue to display the entered data, or the data entry display may otherwise be manually or automatically dimmed or turned off. In a preferred embodiment, the data entry display 4 automatically dims or turns off after a pre-determined period of time. The data entry display 4 is preferably further capable of displaying other numeric and/or alphanumeric data, and/or graphics such as icons, animations, photos, videos, and the like, such as those which may be entered into or recalled from the data memory.

The electronic data device 1 further comprises a reminder display 6 comprising an array of lights coupled to the microprocessor. They are preferably electrically coupled via internal wires within the housing 3. The reminder display 6, which is separate from the data entry display, serves to display visual signals which indicate a continuous countdown of time responsive to, or corresponding to, the time and/or date data recalled from the data memory. This time and/or date data preferably relates to an event which a user is to be reminded of.

The reminder display 6 may comprise any suitable array of lights sufficient to display a signal indicating the desired continuous countdown of time. In a preferred embodiment, shown in FIG. 8, the reminder display 6 comprises a plurality of light emitting diode (LED) lights. Most preferably, the plurality of LED lights are capable of displaying a signal which includes a sequential illumination of said LED lights to indicate a countdown of time, corresponding to time and/or date data from the data memory. In a most preferred embodiment, each LED light is capable of illuminating a different color relative to an adjacent LED light.

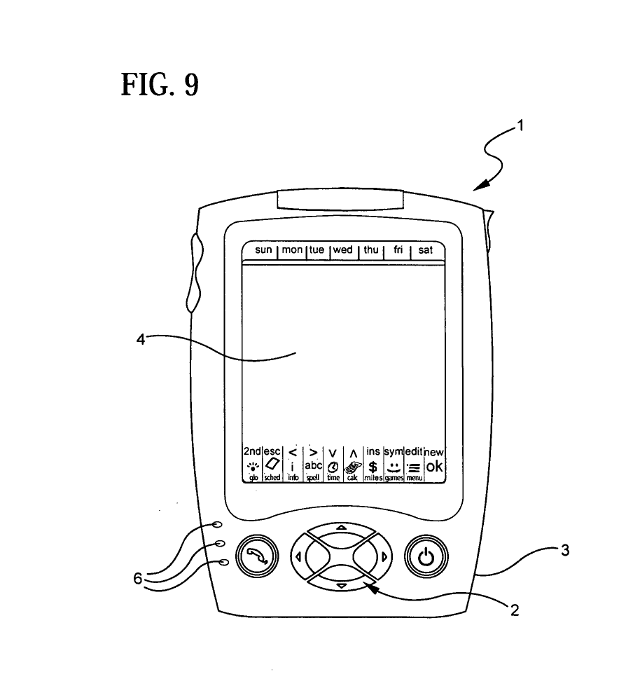

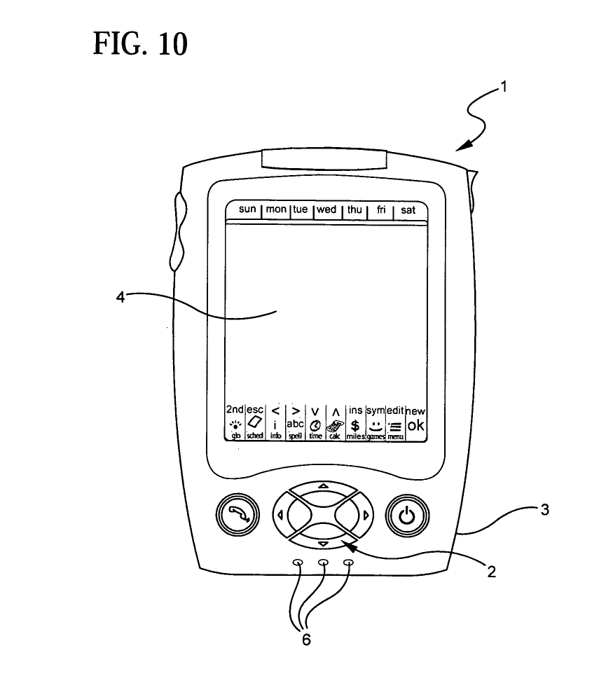

The reminder display's array of lights is preferably linear in arrangement, as shown in FIGS. 8, 9, and 10. FIG. 9 shows a vertical linear reminder display 6 at a left side location of a housing 3, where the electronic data device 1 comprises a hand held data storage device. FIG. 10 shows a horizontal linear reminder display 6 at a bottom location of a housing 3 where the electronic data device 1 comprises a hand held data storage device.

Signals of the reminder display 6 may comprise various colors, lighting sequences, adjustable blink frequencies, and the like. For example, the signals may include the sequential, simultaneous, or independent illumination of various lights or light patterns, depending on various chosen settings. In one preferred embodiment, the reminder display's array of lights are adjusted to illuminate with a first color prior to a deadline, a second color when the deadline is imminent, and a third color to indicate an overdue deadline. In another embodiment, the reminder display's array of lights are adjusted to illuminate with a first blink frequency prior to a deadline, a faster blink frequency when the deadline is imminent, and an even faster blink frequency to indicate an overdue deadline. In a most preferred embodiment, the reminder display 6 comprises a linear traffic-light style arrangement comprising a green light, a yellow light, and a red light, which lights are capable of sequential illumination in that order. However, any desired combination of colors, lighting sequences, blink frequencies, and the like may be chosen. One means of conserving battery power is to modify the blink frequency so that the display does not blink continuously. For example, one may cause the green light to blink once when an appointment is entered. Then, the day before an appointment, the display blinks yellow every ten seconds for the first 5 minutes of each hour. On the day of an appointment, the display can blink red for the first 10 seconds of each hour.

Optionally, the electronic data device 1 of the invention may further include an audio component such as an audio signal mechanism. The audio component may comprise a sound chip, voice chip, sound card, microphone, and/or speaker or the like for emitting and/or recording sounds and sound signals, such as sound beeps, alarms, songs, ringtones, musical notes, voice prompts, human voice messages, pre-programmed messages, and the like. Such emitted and/or recorded sounds and sound signals may serve as an audio reminder signal or the like, and may be responsive to, or corresponding to, time and/or date data recalled from the data memory further comprises the step of emitting a sound which serves as an audio reminder signal, responsive to time and/or date data recalled of the data memory. In one preferred embodiment, the audio component emits a continuous sound signal, such as a repetitive beeping. In a further preferred embodiment, this continuous sound signal is substantially simultaneous with a visual signal of the reminder display.

The electronic data device 1 preferably further comprises a power source, which may comprise any suitable conventional power supplying means known in the art. Preferably, the power source comprises an internal power source such as a battery, a solar cell, a miniature fuel cell or the like. The power source preferably comprises an internal battery located within the housing 3, and which battery is electrically coupled via internal wires to the microprocessor, for supplying power to the data entry display 4, the reminder display 6, the input arrangement 2, and the data memory. The housing 3 may comprise an access compartment such as a rear access door or the like for accessing the battery. The housing 3 may further comprise one or more additional control buttons for controlling other features of the inventive electronic data device such as contrast, color, volume, and the like.

In a most preferred embodiment of this invention, an electronic reminder device is attached, via an attachment mechanism comprising a substantially planar clip, to a file on a user's desk, wherein time and/or date data entered into the data memory relates to an event or deadline associated with the file. Signals displayed by the reminder display indicate a continuous countdown of time responsive to, or corresponding to, the time and/or date data recalled of the data memory and relating to the file event or deadline. These signals are monitored by a user, thereby reminding the user of the file event or deadline.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. An electronic reminder device which comprises:
a) a housing comprising an attachment mechanism for attaching the housing to an article;
b) a microprocessor within the housing, which microprocessor is coupled to a data memory which stores time and/or date data; and which microprocessor is capable of conducting a continuous countdown of time corresponding to the time and/or date data stored in the data memory;
c) an input arrangement coupled to the microprocessor, for entering time and/or date data into the data memory via the microprocessor;
d) a data entry display coupled to the microprocessor, for displaying the entry of time and/or date data into the data memory; and
e) a reminder display comprising an array of lights coupled to the microprocessor for displaying signals which indicate a continuous countdown of time corresponding to the time and/or date data from the data memory.

2. The device of claim 1 wherein the attachment mechanism comprises a substantially planar clip.

3. The device of claim 1 wherein the attachment mechanism comprises a substantially planar magnet.

4. The device of claim 1 wherein the attachment mechanism is removable from the housing.

5. The device of claim 1 wherein the attachment mechanism is not removable from the housing.

6. The device of claim 1 wherein the input arrangement comprises at least one depressible key.

7. The device of claim 1 wherein the reminder display comprises a plurality of LED lights.

8. The device of claim 7 wherein the plurality of LED lights are capable of displaying a signal, which signal includes a sequential illumination of said LED lights to indicate a countdown of time, corresponding to time and/or date data from the data memory.

9. The device of claim 8 wherein each LED light is capable of illuminating a different color relative to an adjacent LED light.

10. The device of claim 1 wherein the data entry display comprises an LCD screen.

11. The device of claim 1 which further comprises an audio component capable of emitting and/or recording sounds.

12. The device of claim 11 wherein the audio component is capable of emitting and/or recording human voice messages.

13. A method of reminding a user of an event, which method comprises:
I) providing an electronic reminder device which comprises
a) a housing comprising an attachment mechanism for attaching the housing to an article;
b) a microprocessor within the housing, which microprocessor is coupled to a data memory which stores time and/or date data; and which microprocessor is capable of conducting a continuous countdown of time corresponding to the time and/or date data stored in the data memory;
c) an input arrangement coupled to the microprocessor, for entering time and/or date data into the data memory via the microprocessor;
d) a data entry display coupled to the microprocessor, for displaying the entry of time and/or date data into the data memory; and
e) a reminder display comprising an array of lights coupled to the microprocessor for displaying signals which indicate a continuous countdown of time corresponding to the time and/or date data from the data memory;
II) entering time and/or date data with the input arrangement, into the data memory via the microprocessor, which time and/or date data is displayed on the data entry display and wherein the time and/or date data relates to an event; and
III) monitoring signals of the reminder display, which signals indicate a continuous countdown of time responsive to time and/or date data recalled of the data memory and relating to the event, thereby reminding a user of the event.

14. The method of claim 13 which further comprises the step of attaching the electronic reminder device, via the attachment mechanism, to an article.

15. The method of claim 13 wherein the attachment mechanism comprises a substantially planar clip.

16. The method of claim 13 wherein the attachment mechanism comprises a substantially planar magnet.

17. The method of claim 13 wherein the reminder display comprises a plurality of LED lights.

18. The method of claim 17 wherein the plurality of LED lights are capable of displaying a signal, which signal includes a sequential illumination of said LED lights to indicate a countdown of time, corresponding to time and/or date data from the data memory.

19. The method of claim 18 wherein each LED light is capable of illuminating a different color relative to an adjacent LED light.

20. The method of claim 13 wherein the electronic reminder device further comprises an audio component capable of emitting and/or recording sounds.

21. The method of claim 13 which further comprises the step of emitting a sound which serves as an audio reminder signal, responsive to time and/or date data recalled of the data memory.

22. The method of claim 20 wherein the audio component is capable of emitting and/or recording human voice messages.

23. A hand held electronic data device which comprises:
a) a housing;
b) a microprocessor within the housing, which microprocessor is coupled to a data memory which stores time and/or date data; and which microprocessor is capable of conducting a continuous countdown of time corresponding to the time and/or date data stored in the data memory;
c) an input arrangement coupled to the microprocessor, for entering time and/or date data into the data memory via the microprocessor;
d) a data entry display coupled to the microprocessor, for displaying the entry of time and/or date data into the data memory; and
e) a reminder display comprising an array of lights coupled to the microprocessor for displaying signals which indicate a continuous countdown of time corresponding to the time and/or date data from the data memory.

24. The hand held electronic data device of claim 23 wherein the reminder display comprises a plurality of LED lights.

25. The hand held electronic data device of claim 24 wherein the plurality of LED lights are capable of displaying a signal, which signal includes a sequential illumination of said LED lights to indicate a countdown of time, corresponding to time and/or date data from the data memory.

26. The hand held electronic data device of claim 25 wherein each LED light is capable of illuminating a different color relative to an adjacent LED light.

27. The hand held electronic data device of claim 23 wherein the housing comprises an attachment mechanism for attaching the housing to an article.

28. The hand held electronic data device of claim 23 which comprises a data storage organizer.

29. The hand held electronic data device of claim 23 wherein the electronic reminder device further comprises an audio component capable of emitting and/or recording sounds.

30. The method of claim 29 wherein the audio component is capable of emitting and/or recording human voice messages.
